(19) United States
(12) Patent Application Publication
(10) Pub. No.: US 2007/0019983 A1
(43) Pub. Date: Jan. 25, 2007

(54) Image forming apparatus having transfer belt

(75) Inventor: Eun-sang Park, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/350,058

(22) Filed: Feb. 9, 2006

(30) Foreign Application Priority Data
Jul. 21, 2005 (KR) 2005-0066275

(51) Int. Cl. G03G 15/16

(52) U.S. Cl. 399/101; 399/297

(57) ABSTRACT

An image forming apparatus has a transfer belt including a transfer belt that transfers a toner image transferred from a photographic drum. A vibrator-bar is disposed inside of the transfer belt to contact the back side of the transfer belt. Preferably, the vibrator-bar applies ultrasonic vibrations. A cleaning blade and a cleaning roller may be disposed downstream of the vibrator-bar.

### CROSS-REFERENCE TO RELATED APPLICATIONS

This application claims the benefit under 35 U.S.C. § 119(a) of Korean Patent Application No. 2005-66275, filed on Jul. 21, 2005, the entirety of which is hereby incorporated by reference.

### BACKGROUND OF THE INVENTION

1. Field of the Invention

The present invention relates to an image forming apparatus having a transfer belt. More particularly, the present invention relates to an image forming apparatus removes residual toner remaining on a transfer belt by applying vibrations to the transfer belt.

2. Description of the Related Art

In image forming apparatuses, such as printers, copiers or facsimiles, an electrostatic latent image is developed on a photosensitive drum, and the developed image is transferred onto paper. In color image forming apparatuses among the image forming apparatuses, generally, a transfer belt mode is applied to enhance the quality of a color image.

FIG. 1 shows a structure of a color printer as one example of the color image forming apparatuses (Korean Patent No. 477661). With reference to FIG. 1, a printer 100 includes an optical photographic drum 110, a charger 112 for charging the photographic drum 110, and a laser scanning unit 120 for scanning light on a charged photographic drum to form an electrostatic latent image of a desired image. A developing unit 130 develops the electrostatic latent image by using four-colored toners of yellow (Y), magenta (M), cyan (C) and black (K) to form a toner image. A transfer unit 140 transfers, onto a paper sheet S, the four color-developed image as being sequentially transferred one upon another from the photographic drum 110. A fixer 150 fixes the image by heating and pressurizing the paper sheet S. The transfer unit 140 includes a transfer belt 141 and a transfer roller 142.

In the color printer 100, when the charger 112 charges the photographic drum 110, the laser scanning unit 120 scans light and forms the electrostatic latent image of the image to be developed in a first color. For example, when developing the image in yellow color Y, a yellow color developing unit 130Y develops the electrostatic latent image as formed in the photographic drum 110 by using yellow color toner, thereby forming a toner image. The yellow image as developed in this manner is transferred to the transfer belt 141. In the same manner, the image is subsequently developed in magenta color M, cyan color C and black color K and transferred, thereby finally forming a desired color image on the transfer belt 141. The toner image as transferred is transferred onto the paper sheet S, which is supplied between the transfer belt 141 and the transfer roller 142 from a paper feeding cassette 170, and is completely fixed on the paper sheet by heat and pressure when passed through the fixer 150.

In this image forming process, when the toner image is transferred from the transfer belt 141 onto the paper sheet S, a part of the toner that forms the image is not transferred and remains on the transfer belt 141. The residual toner must be removed to prepare a next printing process, and for this purpose, a separate transfer belt cleaning means 160 is provided at one side of the transfer unit 140.

A general transfer belt cleaning means 160 includes a cleaning blade 161 that contacts the surface of the transfer belt 141, and a waste toner collecting container 162 to collect the residual toner T. However, it is impossible to perfectly remove the toner remaining on the surface of the transfer belt 141 by only the cleaning blade 161.

In order to solve the aforementioned problem, various techniques have been developed (for example, Japanese Laid-Open Patent Publication Nos. 2000-203078, Hei 11-327390, 2001-324905 and Hei 2-116868, and Korean Patent No. 476958).

FIG. 2 shows a structure of a transfer belt cleaning device that is a part of a wet-type color printer as an example of an image forming apparatus 200, which is disclosed in Korean Patent No. 476958. As shown in FIG. 2, the transfer belt cleaning device 260 includes a cleaning blade 261, a developing solution collecting container 262, a cleaning roller 263, and a cleaning electrode roller 264, thereby removing the residual developing solution T remaining on the transfer belt 241 by three steps. Although the cleaning device is effective for the wet-type image forming apparatus, a disadvantage is that it cannot be applied to a dry-type image forming apparatus.

Additionally, Japanese Laid-Open Patent Publication No. Hei 11-327390 discloses a device for removing an image forming material by applying vibrations to a blade when removing the image forming material remaining on the transfer belt. FIG. 3 schematically shows a structure of such an image forming material removing device. As shown in FIG. 3, the image forming material removing device 360 conveys a paper sheet S in a predetermined direction by rollers 343 and 344 and the image forming material on the paper sheet is adsorbed on a conveying belt 341. Subsequently, as a vibrating part 364 applies vibrations to a holder 363, a blade 361 mounted on the holder 363 more easily removes the image forming material as adsorbed above, that is, waste toner T. However, this technique is to recycle a paper sheet on which the image forming material is inadvertently formed. Moreover, when removing the residual waste toner, although the blade is vibrated, the vibration is not sufficiently transmitted onto the transfer belt and thus, this technique is insufficient for removing small waste toner.

As described above, in the image forming apparatus having the transfer belt, such as the dry-type or wet-type color image forming apparatus, it is required to more securely remove the residual toner remaining on the transfer belt to enhance the quality of the formed image.

Accordingly, a need exists for an image forming apparatus in which residual toner is removed from the transfer belt by applying vibrations thereto.

### SUMMARY OF THE INVENTION

Accordingly, it is an object of the present invention to provide an image forming apparatus that is capable of easily and efficiently removing small residual toner remaining on the surface of a transfer belt by applying ultrasonic vibrations to the transfer belt.

The above object of the present invention is substantially realized by providing an image forming apparatus including a transfer belt for transferring a toner image transferred from a photographic drum onto a paper sheet, and a vibrator-bar disposed at the transfer belt to contact the back side of the transfer belt.

The vibrator-bar may be one that generates ultrasonic vibrations, and, preferably it is disposed between a steering roller and a guide roller.

A cleaning blade may be further disposed or a cleaning roller may be provided downstream of the vibrator-bar, or the cleaning blade and the cleaning roller may be disposed together. Preferably, a blade back up roller may be further disposed at the backside of the transfer belt that is opposite to the cleaning blade.

A waste toner collecting container may be further disposed around the transfer belt in the image forming apparatus.

Other objects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above aspects and features of the present invention will be more apparent by describing certain exemplary embodiments of the present invention with reference to the accompanying drawings, in which:

FIG. 1 schematically shows a structure of an image forming apparatus having one conventional transfer belt;

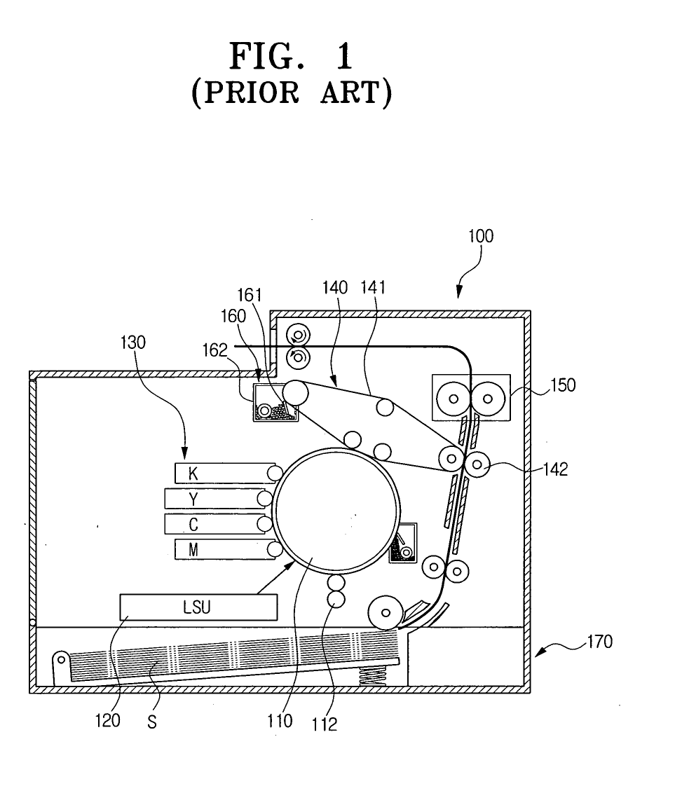

FIG. 2 schematically shows a structure of an image forming apparatus having another conventional transfer belt;

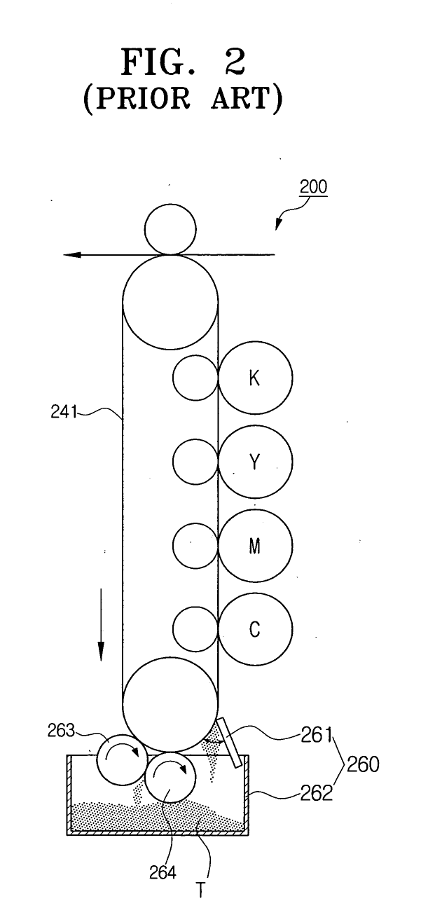

FIG. 3 schematically shows a structure of an image forming material removing device in an image forming apparatus having still another conventional transfer belt;

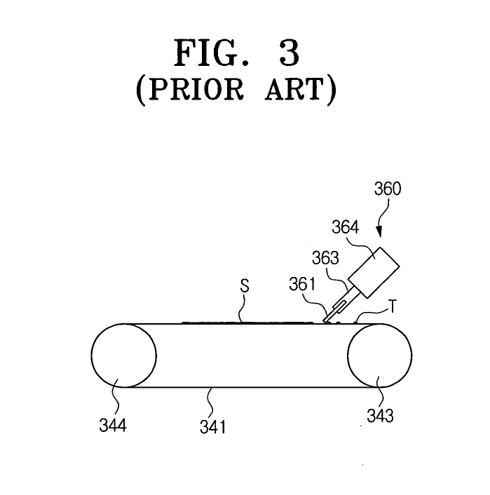

FIG. 4 schematically shows a structure of an image forming apparatus according to a first exemplary embodiment of the present invention;

FIG. 5 is a perspective view of a transfer belt of FIG. 4;

FIG. 6 is a perspective view of a transfer belt in an image forming apparatus according to a second exemplary embodiment of the present invention;

FIG. 7 schematically shows a structure of an image forming apparatus according to a third exemplary embodiment of the present invention; and

FIG. 8 schematically shows a structure of an image forming apparatus according to a fourth exemplary embodiment of the present invention.

Throughout the drawings, the same drawing reference numerals will be understood to refer to the same elements, features, and structures.

### DETAILED DESCRIPTION OF EXEMPLARY EMBODIMENTS

Certain exemplary embodiments of the present invention will be described in detail with reference to the included drawings below.

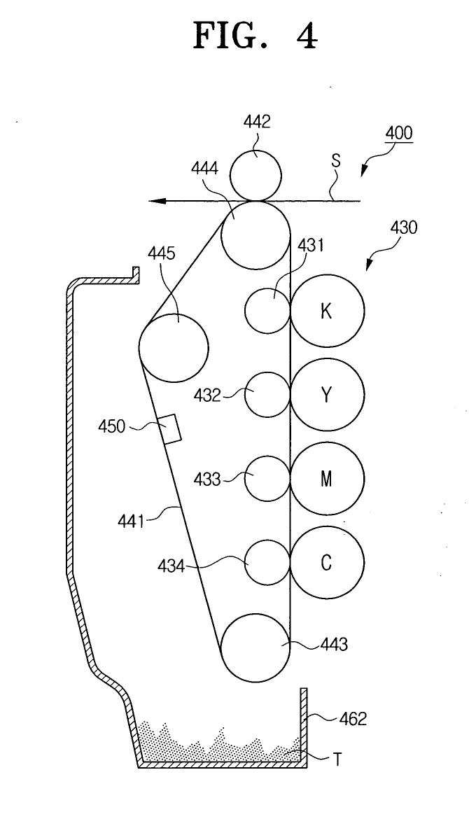

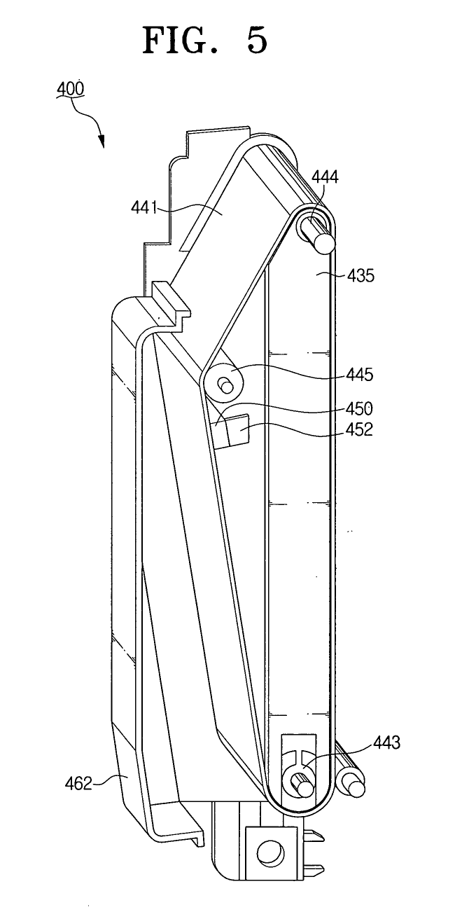

FIG. 4 schematically shows a structure of an image forming apparatus according to a first exemplary embodiment of the present invention. FIG. 5 is a perspective view of a transfer belt of FIG. 4. With reference to FIGS. 4 and 5, an image forming apparatus 400 according to a first exemplary embodiment of the present invention includes a transfer belt 441 for transferring a toner image transferred from photographic drums 430C, 430M, 430Y and 430K. A vibrator-bar 450 disposed inside of the transfer belt 441 contacts the back side of the transfer belt.

The transfer belt 441 is disposed to be wound on a number of back up rollers 431, 432, 433 and 434, a stirring roller 443, a driving roller 444 and a guide roller 445, which are all positioned in a printer body, and to circularly travel along a certain track. The transfer belt 441 contacts the photographic drums 430C, 430M, 430Y and 430K by the back up rollers 431, 432, 433 and 434 among the back up rollers, and the toner image of the photographic drums is transferred to the transfer belt 441. The transferred toner image is re-transferred onto a paper sheet S passing between the transfer belt 441 and the transfer roller 442 by the transfer belt 441. In FIGS. 4 and 5, the transfer belt 441 is driven counterclockwise by the driving roller 444, and the tension of the transfer belt 441 is controlled by the stirring roller 443.

Preferably, the vibrator-bar 450 is one that generates ultrasonic vibrations. As the frequency of vibrations of the ultrasonic vibrator-bar is faster than the speed of rotation of the transfer belt, the ultrasonic vibrator-bar removes the residual toner. The vibrator-bar may be disposed between the stirring roller 443 and the guide roller 445. The vibrations of the vibrator-bar 450 is transmitted in the section between the stirring roller 443 and the guide roller 445. The vibrator-bar may be disposed in a transfer belt frame 435 by a support 452.

In a first exemplary embodiment of the present invention, a waste toner collecting container 462 may be further disposed around the transfer belt 441. Preferably, the waste toner collecting container 462 is entirely covered up tight, except for an opening that the transfer belt 441 passes through. As shown in FIGS. 4 and 5, when the transfer belt 441 is vertically disposed, waste toner freely falls down by the vibrations of the vibrator-bar 450 and drops into the waste toner collecting container 462.

In the image forming apparatus 400 of the aforementioned structure, the structure of the apparatus may be simplified because it is possible to remove even small residual toner by applying the ultrasonic vibrations to the transfer belt 441 by the vibrator-bar 450 without disposing the existing cleaning blade or cleaning roller. Specifically, as the image forming apparatus 400 of the present invention gives a shock to the transfer belt 441 by the ultrasonic vibrations, toner sticking to the transfer belt may even be removed when the paper sheet is jammed.

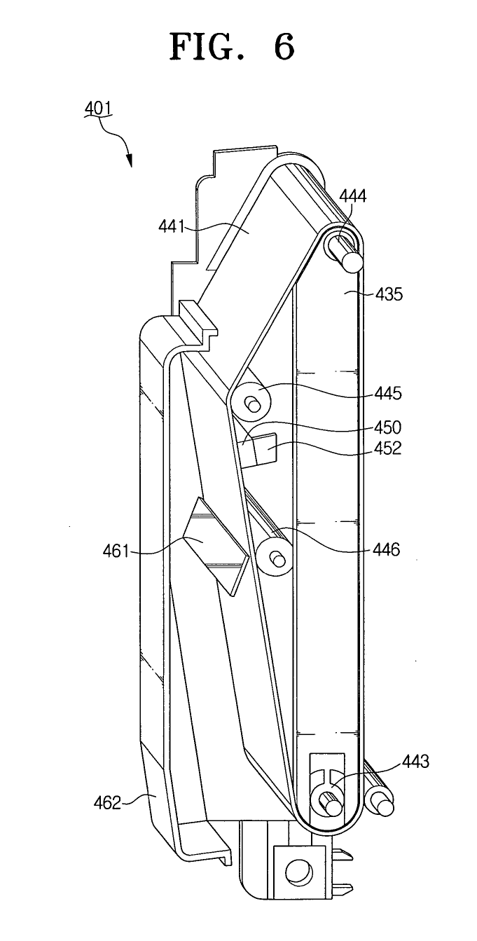

FIG. 6 is a perspective view of a transfer belt 441 in an image forming apparatus 401 according to a second exemplary embodiment of the present invention. The image forming apparatus 401 according to the second exemplary embodiment is substantially similar to the image forming apparatus 400 as described in reference to the first exemplary embodiment, except that a cleaning blade 461 is disposed therein. The same reference numbers will be used to denote the same constituents as those of the first exemplary embodiment. Thus, any redundant description is omitted.

The image forming apparatus 401 of the second exemplary embodiment further includes a cleaning blade 461 in addition to the transfer belt 441 and the vibrator-bar 450 of the image forming apparatus 400 of the first exemplary embodiment. Preferably, the cleaning blade 461 is disposed downstream of the vibrator-bar 450. Preferably, the blade back up roller 446 is disposed at the backside of the transfer belt, that is, the side that is opposite to the cleaning blade.

The image forming apparatus 401 of the aforementioned structure primarily removes small toner by the vibrator-bar 461, and when the transfer belt 441 is in operation, the waste toner removal is further facilitated by the cleaning blade 461 thereby easing removal of hardened waste toner. Specifically, in the image forming apparatus 401, as the pressure of the cleaning blade 461 against the back up roller 446 may not be high, there is an advantage of relatively extending the usage time of the blade.

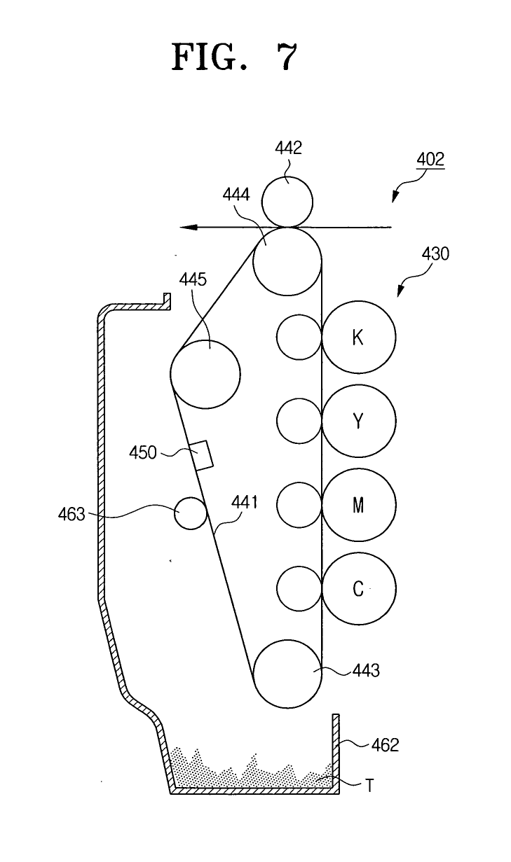

FIG. 7 schematically shows a structure of an image forming apparatus according to a third exemplary embodiment of the present invention. The image forming apparatus 402 according to the third exemplary embodiment is substantially similar to the image forming apparatus 400 as described in reference to the first exemplary embodiment, except that a cleaning roller 463 is disposed therein. The same reference numbers are also used to denote the same constituents as those of the first exemplary embodiment. Thus, any redundant description is omitted.

The image forming apparatus 402 of the third exemplary embodiment further includes the cleaning roller 463 in addition to the transfer belt 441 and the vibrator-bar 450 of the image forming apparatus 400 of the first exemplary embodiment. Preferably, the cleaning roller 463 is disposed downstream of the vibrator-bar 450 in the same manner as the cleaning blade 461. Preferably, a brush or sponge is provided in the cleaning roller 463.

The image forming apparatus 402 of the aforementioned structure primarily removes the small toner by the vibrator-bar 450, and when the transfer belt 441 is in operation, removal of the waste toner is further facilitated by the cleaning roller 463, thereby easing removal of the hardened waste toner. Specifically, in the image forming apparatus 402, the surface of the transfer belt may be very clean by the cleaning roller 463.

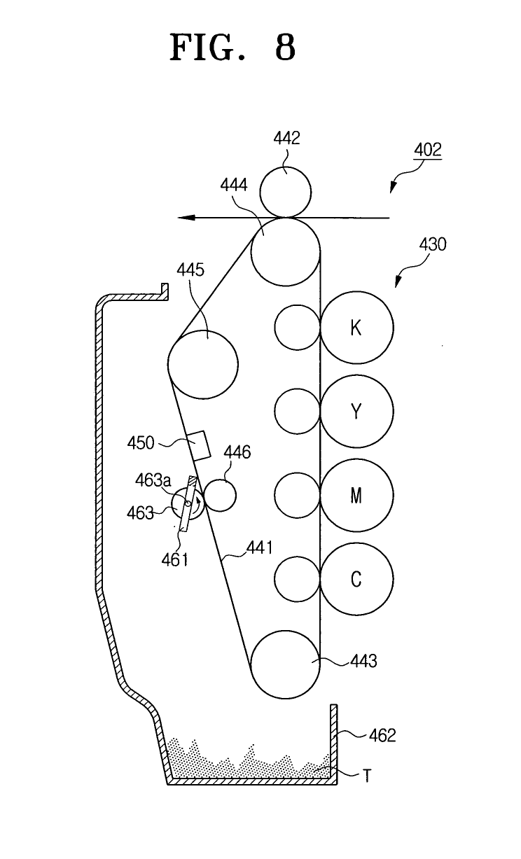

FIG. 8 schematically shows a structure of an image forming apparatus according to a fourth exemplary embodiment of the present invention. The image forming apparatus 403 according to the fourth exemplary embodiment is substantially similar to the image forming apparatus 400 as described in reference to the first exemplary embodiment, except that both the cleaning blade 461 and the cleaning roller 463 are disposed together therein. The same reference numbers are used to denote the same constituents as those of the first exemplary embodiment. Thus, any redundant description is omitted.

The image forming apparatus 403 of the fourth exemplary embodiment further includes the cleaning blade 461 and the cleaning roller 463 in addition to the transfer belt 441 and the vibrator-bar 450 of the image forming apparatus 400 of the first exemplary embodiment. Preferably, the cleaning blade 461 and the cleaning roller 463 are also disposed downstream of the vibrator-bar 450, and the blade back up roller 446 is disposed at the back side of the transfer belt, that is, the side opposite to the cleaning blade 461. The cleaning roller 463 and the cleaning blade 461 may be disposed spaced apart from each other, and both may be disposed on the line that is extendable from an axis 463a of the cleaning roller 463.

The image forming apparatus 403 of the aforementioned structure primarily removes the small toner by the vibrator-bar 450, and when the transfer belt 441 is in operation, the waste toner may be removed by the cleaning blade 461 and the cleaning roller 463, thereby easing removal of hardened waste toner. As a result, the surface of the transfer belt is much more clean, thereby enhancing the quality of an image.

As described above, the image forming apparatus according to exemplary embodiments of the present invention is capable of easily removing small toner remaining on the surface of the transfer belt by applying ultrasonic vibrations to the transfer belt. Consequently, this enables the transfer belt to be used longer, uniform image quality, and enhanced image quality compared to the conventional image forming apparatus using the existing, conventional cleaning blade.

Furthermore, as the image forming apparatus according to exemplary embodiments of the present invention is capable of removing the toner remaining on the surface of the transfer belt by mounting only the ultrasonic vibrator-bar, it enables the structure of the apparatus to be simplified.

Furthermore, the image forming apparatus according to exemplary embodiments of the present invention may employ the cleaning blade and the cleaning roller, together with the vibrator-bar, it easily removes the residual toner even though the toner in an excess of quantity remains in a hardened state, even though a paper jam may have occurred, and the usage life of the cleaning blade and the cleaning roller is lengthened.

The foregoing embodiments and advantages are merely exemplary and are not to be construed as limiting the present invention. The present teaching may be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. An image forming apparatus having a transfer belt, comprising:
a transfer belt for transferring a toner image transferred from a photographic drum onto a paper sheet; and
a vibrator-bar disposed inside of the transfer belt to contact a back side of the transfer belt.

2. The apparatus as claimed in claim 1, wherein
the vibrator-bar generates ultrasonic vibrations.

3. The apparatus as claimed in claim 2, wherein
the vibrator-bar is disposed between a stirring roller and a guide roller.

4. The apparatus as claimed in claim 1, wherein
a waste toner collecting container is substantially disposed around the transfer belt.

5. An image forming apparatus having a transfer belt, comprising:
a transfer belt for transferring a toner image from a photographic drum onto a paper sheet;
a vibrator-bar disposed inside of the transfer belt to contact the back side of the transfer belt; and
a cleaning blade disposed downstream of the vibrator-bar.

6. The apparatus as claimed in claim 5, wherein
the vibrator-bar generates ultrasonic vibrations.

7. The apparatus as claimed in claim 6, wherein
the vibrator-bar is disposed between a stirring roller and a guide roller.

8. The apparatus as claimed in claim 5, wherein
a blade back up roller is disposed at the back side of the transfer belt opposite to the cleaning blade.

9. The apparatus as claimed in claim 5, wherein
a waste toner collecting container is substantially disposed around the transfer belt.

10. An image forming apparatus having a transfer belt, comprising:
a transfer belt for transferring a toner image from a photographic drum onto a paper sheet;
a vibrator-bar disposed inside of the transfer belt to contact the back side of the transfer belt; and
a cleaning roller disposed downstream of the vibrator-bar.

11. The apparatus as claimed in claim 10, wherein
the vibrator-bar generates ultrasonic vibrations.

12. The apparatus as claimed in claim 1, wherein
the vibrator-bar disposed between a stirring roller and a guide roller.

13. The apparatus as claimed in claim 10, wherein
a brush or a sponge is mounted on the cleaning roller.

14. The apparatus as claimed in claim 10, wherein
a waste toner collecting container is disposed substantially around the transfer belt.

15. An image forming apparatus having a transfer belt, comprising:
a transfer belt for transferring a toner image from a photographic drum onto a paper sheet;
a vibrator-bar disposed inside of the transfer belt to contact the back side of the transfer belt; and
a cleaning roller and a cleaning blade disposed downstream of the vibrator-bar.

16. The apparatus as claimed in claim 15, wherein
the vibrator-bar generates ultrasonic vibrations.

17. The apparatus as claimed in claim 16, wherein
the vibrator-bar is disposed between a stirring roller and a guide roller.

18. The apparatus as claimed in claim 15, wherein
a blade back up roller is disposed at the back side of the transfer belt opposite to the cleaning blade.

19. The apparatus as claimed in claim 15, wherein
a brush or sponge is mounted on the cleaning roller.

20. The apparatus as claimed in claim 15, wherein
a waste toner collecting container is substantially disposed around the transfer belt.
